(19) United States
(12) Patent Application Publication
(10) Pub. No.: US 2007/0130202 A1
(43) Pub. Date: Jun. 7, 2007

(54) System and method for automatically generating a searchable plug-in from text files

(75) Inventors: Steven Aoki, San Jose, CA (US); Daryl Keith Bryant, San Jose, CA (US); Jianguo Zhang, Austin, TX (US)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/294,207

(22) Filed: Dec. 3, 2005

(51) Int. Cl. G06F 17/00

(52) U.S. Cl. 707/104.1

(57) ABSTRACT

A plug-in generating system generates a searchable plug-in from text files. The system selects the text files from one or more directories of text files for inclusion in the searchable plug-in. The system converts the selected text files into a plurality of HTML files for providing enhanced search capability of the searchable plug-in. The system compresses the converted HTML files for inclusion into the searchable plug-in. The system generates table-of-contents XML file for listing the converted HTML files. The system packages the converted HTML files and the generated table-of-contents file into the searchable plug-in.

### FIELD OF THE INVENTION

The present invention generally relates to a modular plug-in processing platform and in particular to automatically generating from text files a searchable plug-in for the modular plug-in processing platform.

### BACKGROUND OF THE INVENTION

Conventional modular plug-in processing platforms typically comprise a help system with one or more plug-ins. The plug-ins for the help system provide functionality to a user in allowing the user to read text files provided by developers, view code samples, etc., in support of the modular plug-in processing platform or in support of an application program operating on or in conjunction with the modular plug-in processing platform.

Conventional plug-ins providing a directory of text files to a user are manually generated. The plain text filenames and plain text files are collected from developers or other sources. Text snippets of the text files are manually pasted into pre-existing HTML files. The plug-in is manually created by entering static links in a manually generated XML file. This XML file is added as a plug-in to, for example, a help system. Although this technology has proven to be useful, it would be desirable to present additional improvements.

Manually creating links becomes painstaking for large quantities of files. Because the links in the manually generated plug-in are static, the links require manual updating whenever developers add, remove, or rename any text files. Furthermore, the links are not revised unless the developer or source of the text file informs a plug-in manager. When developers modify the content in the files, the files require recopying; however, the plug-in manager often is not aware of the modification. When aware of the modification, the plug-in manager has to manually copy the file or revise the text snippets previously pasted. Furthermore, a development cycle of a modular plug-in processing platform requires finalization of plug-ins for systems such as help systems relatively early. A plug-in manager is unable to revise the snippets or links past a finalization deadline; consequently, some or all of the information in the plug-in is outdated by the time the help system is released.

What is therefore needed is a system, a computer program product, and an associated method for automatically generating a searchable plug-in from text files that supports searching of the text files. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for automatically generating a searchable plug-in from text files. The present system recursively crawls through a directory and its sub-directories, and selects the text files for inclusion in the searchable plug-in. The present system converts the selected text files into a plurality of HTML files for providing enhanced search capability of the searchable plug-in. The present system compresses the converted HTML files for inclusion into the searchable plug-in. The present system automatically generates the table-of-contents XML file for listing the converted HTML files. The present system packages the converted HTML files and the generated table-of-contents file into the searchable plug-in.

The present system searches the directories of text files and sub-directories of the directories of text files to identify text files for inclusion in the searchable plug-in. In one embodiment, the text files are restricted by a user to a customized set of file extensions. In another embodiment, the user may specify top-level directories to be crawled through for text files by the present system.

The present system may be embodied in a utility program such as a plug-in generating utility program. The present system also provides a method for the user to generate a plug-in comprising text files by specifying one or more top-level input directories as sources of the text files, specifying file extensions that indicate types of text files to be selected, specifying a filename for an XML navigation panel, and specifying an output directory for locating the output plug-in. The present system provides a method for the user to invoke the plug-in generating utility to generate a searchable plug-in.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a plug-in generating system of the present invention can be used;

FIG. 2 is a block diagram of a high-level architecture of the plug-in generating system of FIG. 1;

FIG. 3 is a process flow chart illustrating a method of operation of the plug-in generating system of FIGS. 1 and 2; and

FIG. 4 is an exemplary graphical user interface illustrating in list format contents of a searchable plug-in generated by the plug-in generating system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Internet: A collection of interconnected public and private computer networks that are linked together with routers by a set of standard protocols to form a global, distributed network.

Plug-in: An auxiliary or accessory program that works with a main application to enhance the capability of the main application.

World Wide Web (WWW, also Web): An Internet client—server hypertext distributed information retrieval system.

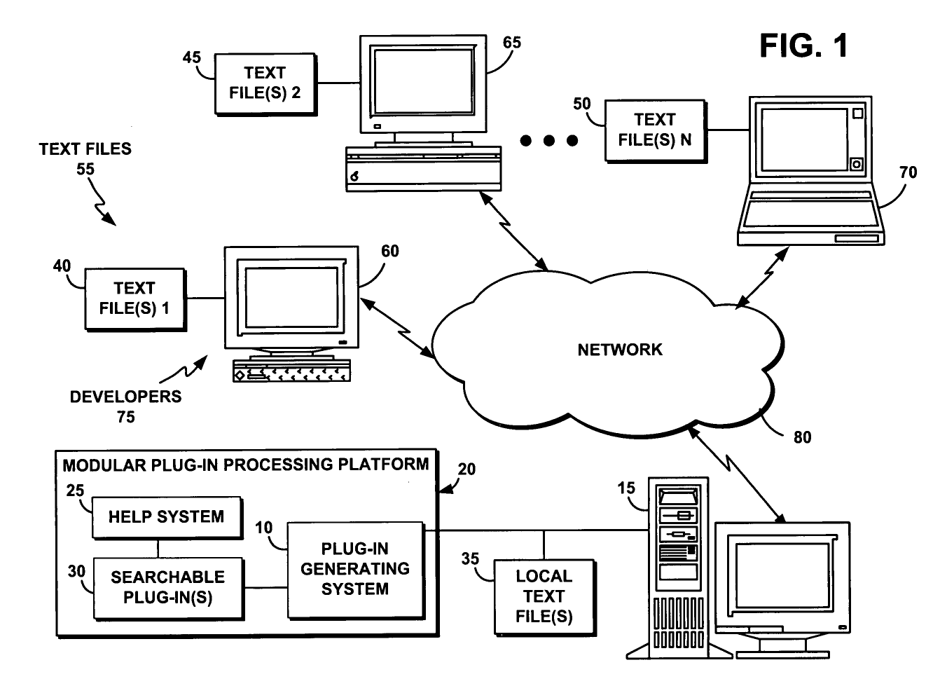

FIG. 1 portrays an exemplary overall environment in which a system, a computer program product, and an associated method (a plug-in generating system or the “system 10”) for automatically generating a searchable plug-in from text files according to the present invention may be used. System 10 comprises a software programming code or a computer program product that is typically embedded within, or installed on a computer 15. Alternatively, system 10 can be saved on a suitable storage medium such as a diskette, a CD, a hard drive, or like devices.

A modular plug-in processing system platform 20 operating on computer 15 comprises system 10. The modular plug-in processing system platform 20 further comprises a help system 25 and one or more searchable plug-ins 30. While described for illustration purposes only in terms of the help system 25, it should be clear that the invention is applicable as well to, for example, any system using a plug-in.

System 10 dynamically and automatically converts text files such as local text files 35, text files 1, 40, text files 2, 45, through text files N, 50 (collectively referenced as text files 55) into a plug-in such as the searchable plug-in 30. Developers are represented by a variety of computers such as computers 60, 65, 70 (collectively referenced as developers 75). In general, developers 75 generate text files 55.

System 10 accesses text files 1, 40, text files 2, 45, through text files N, 50, via a network 80 such as the Internet. System 10 may access text files 55 either manually, or automatically through the use of an application. While the system 10 is described in connection with the Internet, the system 10 can be used with a stand-alone directory of text files that may have been derived from the WWW or other sources.

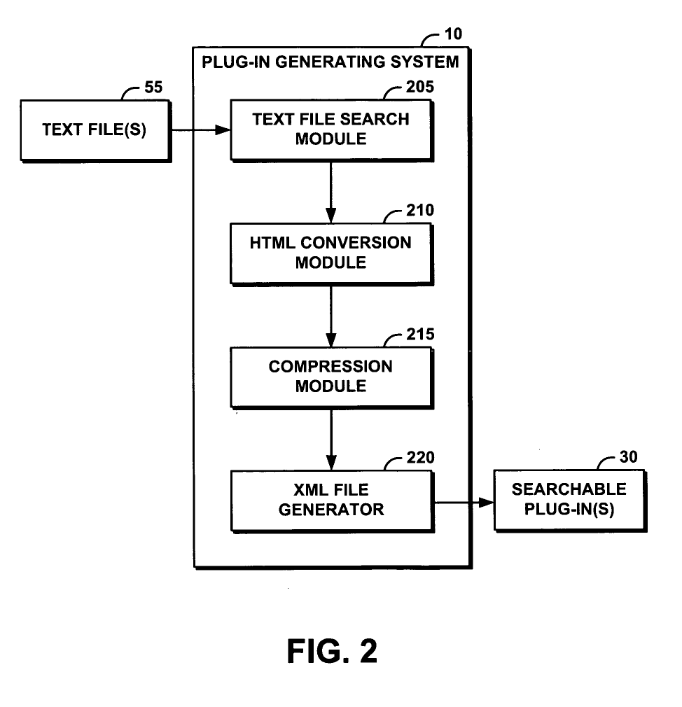

FIG. 2 illustrates a high-level hierarchy of system 10. System 10 comprises a text file search module 205, an HTML conversion module 210, a compression module 215, and an XML file generator 220. Input to system 10 is one or more text files 55. Output generated by system 10 is one or more searchable plug-ins 30. System 10 automatically, dynamically, and recursively crawls through directories of text files 55 to select text files for use in generating the searchable plug-ins 30. System 10 processes the selected text files into one or more searchable plug-ins 30, searchable by the help system 25. System 10 selects specific file types as directed by a user for inclusion in the searchable plug-ins 30.

System 10 further comprises a readme file, a sample batch file, Java classes, and exemplary text files. The readme file provides documentation on system 10 and instructions on use of system 10. The exemplary text files are provided for experimentation by the user in implementing system 10. The sample batch file performs compression module 215, and runs the Java classes that perform text file search module 205, HTML conversion module 210, and XML file generator 220.

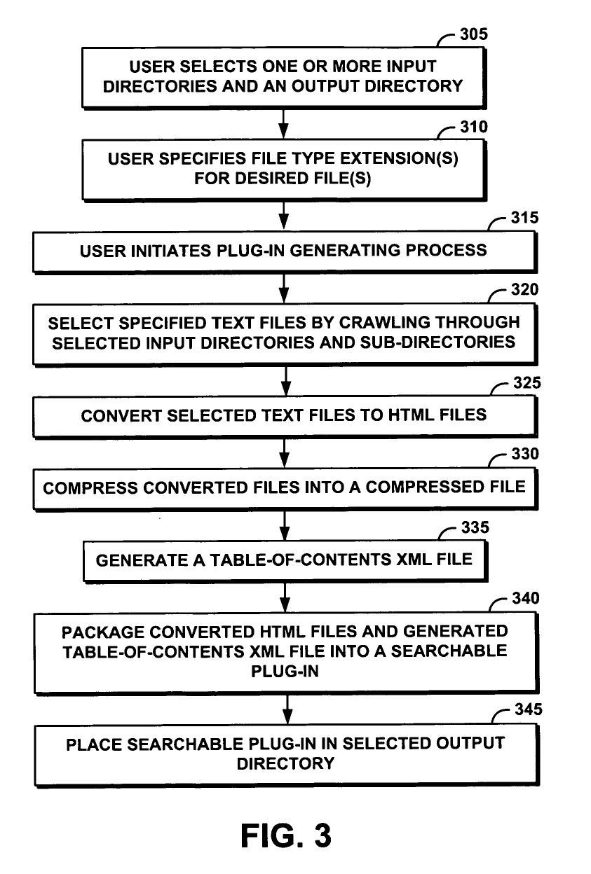

With further reference to FIG. 3, it illustrates a method 300 of system 10 in automatically and dynamically generating the searchable plug-ins 30 from text files 55. A user selects a top-level input directory to crawl through and an output directory (step 305). Step 305 can be repeated until all of the input directories that comprise the text files 55 have been crawled through. The output directory directs system 10 where to place the searchable plug-in 30. The user further specifies one or more file type extensions for desired text files selected from the text files 55 (step 310); system 10 searches text files 55 for the specified file type extensions. The user specifies a filename for the XML file generated by system 10. Help system 25 uses the XML file as a manifest to read in searchable plug-in(s) 30. The XML file can also be displayed as a navigation pane to browse searchable plug-in(s) 30. Steps 305 and 310 allow the user to customize the output of system 10.

The user initiates the plug-in generating process of system 10 (step 315). The text file search module 205 selects specified text files by crawling through the specified input directories and sub-directories of the specified input directories, searching for text files with the specified file type extensions (step 320). The HTML conversion module 210 converts the selected text files to HTML (step 325), generating HTML files. The HTML conversion module 210 marks up each of the selected text files with basic HTML tags, and appends an “.htm” extension to each converted file. The HTML conversion module 210 further replaces special characters in the selected text files with text entities. System 10 embeds the text of the selected text files into an HTML template without tampering with the actual text.

The compression module 215 compresses the converted HTML files into a compressed file by, for example, zipping the HTML files into a doc.zip file (step 330). The XML file generator 220 generates a table-of-contents XML file (step 335). The XML file generator 220 scans through the compressed file and populates an XML list in an XML file with links to each of the converted HTML files. The XML file generator 220 packages the converted HTML files and the generated table-of-contents XML file in the searchable plug-in 30 (step 340) and places the searchable plug-in 30 in the selected output directory (step 345).

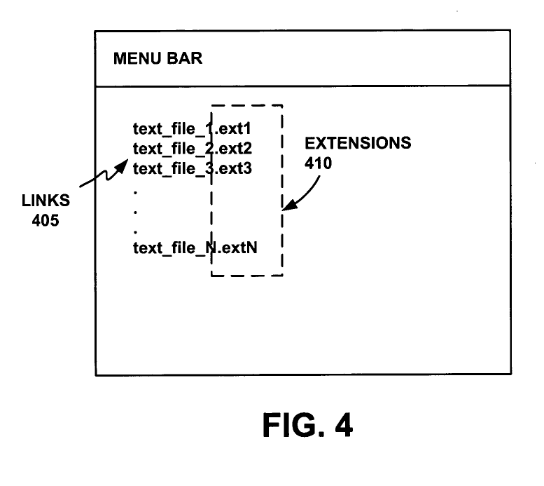

FIG. 4 illustrates an exemplary graphical user interface 400 showing contents of a searchable plug-in 30 generated by system 10. Contents of the searchable plug-in 30 links 405 to the converted HTML files shown in list format. Each of the links 405 is a pointer to an HTML file converted from a text file. Exemplary extensions 410 are shown as ext1, .ext2, .ext3, through .extN. In actuality, extensions 410 may be the same extension or may be different extensions. Extensions 410 comprise those file extensions selected by the user in step 310.

System 10 automatically crawls through the specified text files 55 and dynamically creates the searchable plug-in 30 from those text files 55. When searched, converted HTML files are identified, and the search keywords can be highlighted with HTML tags. Because the plug-in is generated automatically, users do not have to expend time and resources building the plug-in manually. Using system 10, the searchable plug-in 30 is updated dynamically each time that system 10 is run. Ideally, system 10 can run automatically during each build/compilation of the overall product code so that the searchable plug-ins stay up-to-date. This would allow developers 75 to add, remove, rename, or update their text files 55 at any time without the help system 25 or the searchable plug-in 30 becoming outdated. Automation provided by system 10 further removes risk of human error in transcribing text snippets and file names.

It is to be understood that the specific embodiments of the invention that have been described are merely illustrative of certain applications of the principle of the present invention. Numerous modifications may be made to the system and method for automatically generating a searchable plug-in from text files described herein without departing from the spirit and scope of the present invention.

What is claimed is:

1. A processor-implemented method of automatically generating a searchable plug-in from a plurality of text files, comprising:
selecting the text files from at least one directory of text files for inclusion in the searchable plug-in;
converting the selected text files into a plurality of HTML files for providing search capability of the searchable plug-in;
compressing the converted HTML files for inclusion into the searchable plug-in;
generating a table-of-contents XML file for listing the converted HTML files; and
packaging the converted HTML files and the generated table-of-contents file into the searchable plug-in.

2. The method of claim 1, wherein the selected text files are restricted to a customized set of file extensions.

3. The method of claim 1, wherein selecting comprises searching the directory of text files and a plurality of sub-directories of the directories of text files.

4. The method of claim 1, wherein the directory of text files is specified by a client.

5. A processor-implemented system of automatically generating a searchable plug-in from a plurality of text files, comprising:
a text file search module for selecting the text files from at least one directory of text files for inclusion in the searchable plug-in;
an HTML conversion module for converting the selected text files into a plurality of HTML files for providing search capability of the searchable plug-in;
a compression module for compressing the converted HTML files for inclusion into the searchable plug-in;
an XML file generator for generating a table-of-contents XML file for listing the converted HTML files; and
the XML file generator further packaging the converted HTML files and the generated table-of-contents file into the searchable plug-in.

6. The system of claim 5, wherein the text file search module restricts the selected text files to a customized set of file extensions.

7. The system of claim 5, wherein the text file search module searches the directory of text files and a plurality of sub-directories of the directories of text files.

8. The system of claim 5, wherein the directory of text files is specified by a client.

9. A computer program product having program codes stored on a computer-usable medium for automatically generating a searchable plug-in from a plurality of text files, comprising:
a program code for selecting the text files from at least one directory of text files for inclusion in the searchable plug-in;
a program code for converting the selected text files into a plurality of HTML files for providing search capability of the searchable plug-in;
a program code for compressing the converted HTML files for inclusion into the searchable plug-in;
a program code for generating a table-of-contents XML file for listing the converted HTML files; and
a program code for packaging the converted HTML files and the generated table-of-contents file into the searchable plug-in.

10. A computer program product of claim 9, wherein the program code for selecting the text files restricts the selected text files to a customized set of file extensions.

11. The computer program product of claim 9, wherein the program code for selecting the text files searches the directory of text files and a plurality of sub-directories of the directories of text files.

12. The computer program product of claim 9, wherein the directory of text files is specified by a client.
